(19) United States
(12) Patent Application Publication
(10) Pub. No.: US 2009/0172601 A1
(43) Pub. Date: Jul. 2, 2009

(54) SYSTEM AND METHOD FOR VIEWING ARBITRARY HIERARCHIES IN A BROWSER

(75) Inventors: Christian BEHRENS, Wiesloch (DE); Steffen ROTSCH, Rauenberg (DE); Martin SCHOLZ, Nussloch (DE)

Correspondence Address: KENYON & KENYON LLP, ONE BROADWAY, NEW YORK, NY, 10004, US

(73) Assignee: SAP AG, Walldorf (DE)

(21) Appl. No.: 11/965,491

(22) Filed: Dec. 27, 2007

(51) Int. Cl. G06F 3/048

(52) U.S. Cl. 715/853

(57) ABSTRACT

A method and system are provided for displaying a hierarchy of nodes. The method may include, responsive to a request to display a set of nodes, requesting node information for each node from a browser provider. The method may include receiving node information for each node to be displayed from the browser provider. The method may include displaying the set of nodes and the node information for each node at a browser to a user.

### BACKGROUND

Modern businesses utilize management and information technology to design, enact, control, and analyze operational business processes involving humans, organizations, applications, documents and other assets. Software may be provided to help with implementing and executing business processes.

A human capital management (HCM) system may automate various human resource processes. For example, a HCM system may automate the functionality of hiring a new employee, terminating an existing employee, reassigning an employee, granting extended leave, etc. Each functionality may require one or more approvals before the request is granted, and the HCM system automates the process of generating the appropriate requests and collecting completed approvals before granting the request if the process was successfully completed. In addition, a HCM system may provide various workforce analytics, which quantifies various aspects of human resources management within the HCM system. To set up such a process, various customizing tables are required to be maintained by customers.

Business processes may be implemented on an application platform as business scenarios. The application platform may include a plurality of objects, each object represented by a node in a hierarchy. The nodes may be related to each other in child, parent, or sibling relationships. There may be multiple types of objects in the system, each object type including its own unique information.

The nodes may be navigated via a browser. The browser is a software application that enables a user to display and interact with the nodes. For example, a user may navigate among nodes based on their relationships. The nodes may be browsed based on the information associated with each object type.

Previously, a browser was hard coded with node information and how to handle each node. This complicates the maintenance of the browser, as any changes in node structure require revisions in the browsers. As software objects in a system may be extended or added to improve functionality, maintenance of the browser becomes a serious challenge.

Thus, a need exists to provide additional browsing capability to browsers when new objects are added into a system.

### BRIEF DESCRIPTION OF THE DRAWINGS

FIG. 1A depicts an example process for navigating a set of nodes in accordance with an embodiment of the present invention.

FIG. 1B depicts an example process for expanding a child node in accordance with an embodiment of the present invention.

FIG. 2 depicts an example system for navigating a set of nodes in accordance with an embodiment of the present invention.

FIG. 3 depicts an example procedure for navigating a set of nodes in accordance with an embodiment of the present invention.

### DETAILED DESCRIPTION

A method and system are provided for separating hierarchy definition from the browser. A browser may be provided to navigate a hierarchy of nodes, where each node is a software object in a system. A browser provider is provided for each root object or group of related objects in the system, and provides hierarchy definition and interface information of the associated objects to the browser. Interface information includes how to navigate and display the hierarchy associated with the nodes.

Node-specific information, such as a node name, a node context menu, a node icon, and child/parent relationships may also be retrieved by the browser provider and provided to the browser to be displayed. For example, the node-specific information may be stored in entity tables accessible to the browser provider.

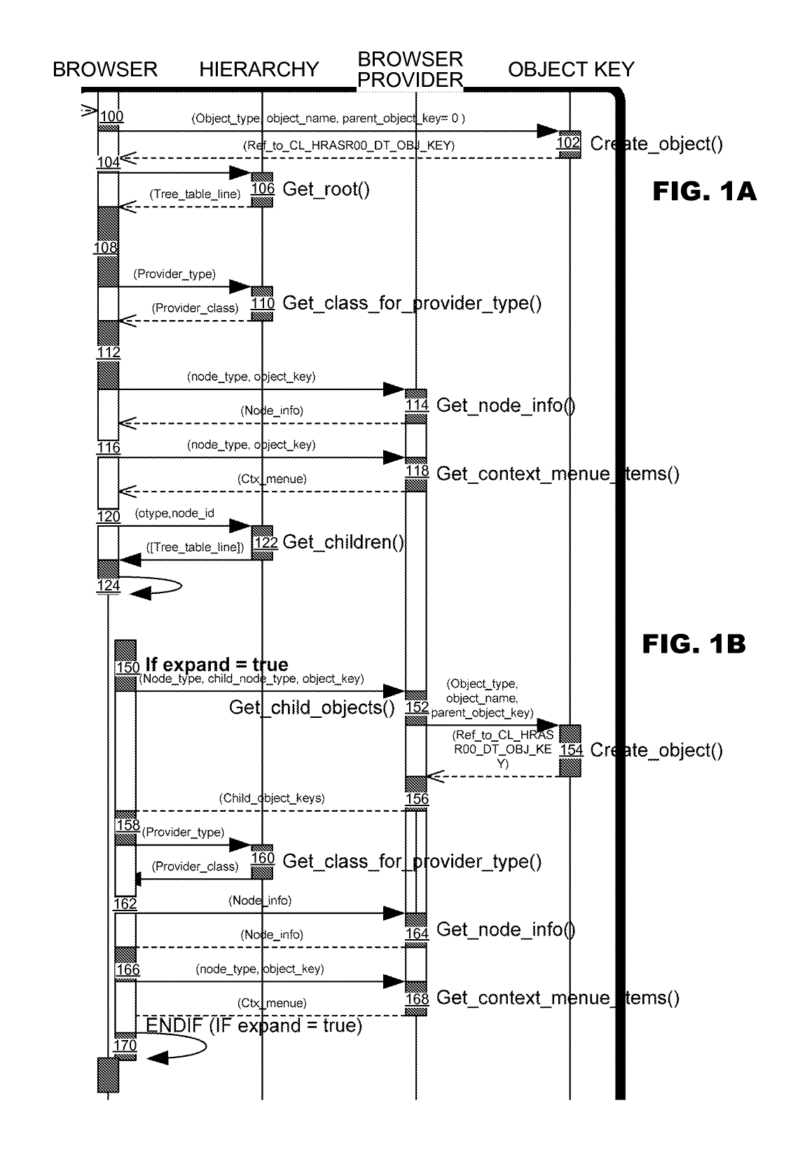

FIG. 1A depicts an example process for navigating a set of nodes in accordance with an embodiment of the present invention. The process may execute on a system as discussed later. The process may involve a browser and a browser provider. Data regarding object hierarchy and object keys may be stored in an accessible storage medium.

In 100, the browser may receive a request to display a node. The node may be, for example, an object in the system. The request may be received from a user wishing to view and navigate a hierarchy of nodes. The user may access the system via a browser executing on a terminal over a network in communication with a server.

In 102, the browser may request an object key for the node to be displayed. In 104, the object key may be received. Each object may be associated with an object key, which may uniquely identify the object within the system.

In 106, the browser may request a root node of the node received in 104. For example, each set of nodes may be associated with a root node, which forms the root node of the hierarchy associated with the set of nodes. In 108, the browser may receive the root node from the storage medium. For example, the root node associated with the node received 104 may be stored with the node or otherwise associated with the node.

In 110, the browser may request an object class associated with the root node. Similar to the root node retrieved in 106, an object class may be stored with the node or otherwise associated with the node in the storage medium.

In 112, the object class may be received by the browser. The browser may request node information from the browser provider. Node information may include a node name, a node icon, and child/parent relationships. The information may be received by the browser and used to display the node. In 114, the browser provider may send the node information to the browser.

In 116, the browser may request a node context menu from the browser provider. The node context menu may be displayed, for example, when a user left-clicks on the node in the browser. The node context menu may include tools and other items relevant to the node. In 118, the node context menu may be sent by the browser provider to the browser.

In 120, the browser may request any children nodes of the node received in 104. The storage medium may associate children nodes with the node in the hierarchy and the children nodes may be transmitted to the browser in 124.

FIG. 1B depicts an example process for expanding a child node in accordance with an embodiment of the present invention. The process may execute after the process depicted in FIG. 1A has executed, and a user indicates a desire to expand children nodes.

In 150, the browser may receive an indication that a user wishes to expand a node to display all associated children nodes. For example, a node may be associated with a set of children and grandchildren nodes.

In 152, the browser provider may provide a set of children and grandchildren nodes associated with the node to be expanded. Nodes may be stored in a tree memory structure, to facilitate retrieval of children nodes.

In 154, the object key of each child and grandchild node may be retrieved from memory by the browser provider. The object keys may be provided to the browser provider in 156.

In 158, the browser may request an object type for each of the child and grandchild node, as retrieved in 156 by the browser provider. Similar to FIG. 1A, the browser may retrieve an object or object type associated with each child node. Objects may be represented by data classes. In 160, the object types may be transmitted to the browser from memory.

In 162, the browser may request node information associated with each child or grandchild node from the browser provider. Node information may include a node name, a node icon, and child/parent relationships. The information may be received by the browser and used to display the node. In 164, the browser provider may send the node information to the browser.

In 166, the browser may request a node context menu associated with the child and grandchild nodes from the browser provider. The node context menu may be displayed, for example, when a user left-clicks on the node in the browser. The node context menu may include tools and other items relevant to the node. In 168, the node context menu may be sent by the browser provider to the browser.

In 170, the child and grandchild nodes may be displayed, and the process may end.

The above process may be executed once for each child node to be displayed, or once for all child nodes associated with a node to be expanded.

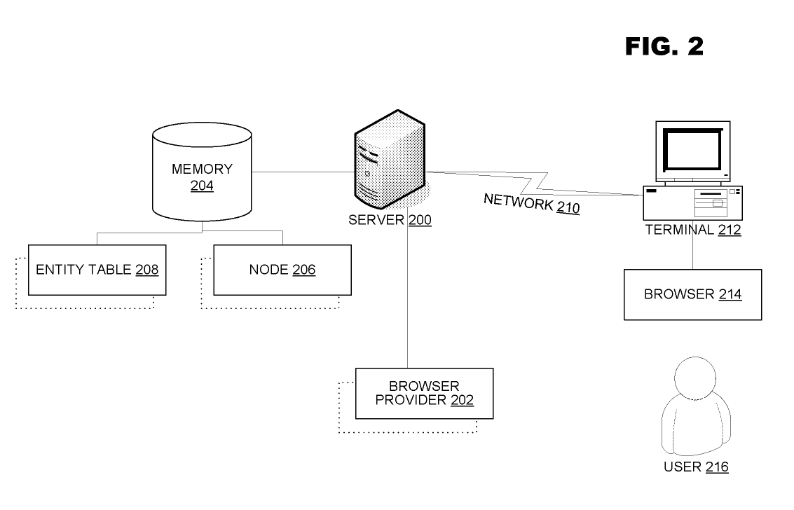

FIG. 2 depicts an example system for navigating a set of nodes in accordance with an embodiment of the present invention. The system may provide a tree display of nodes to a browser, where each node represents an object or object type within a HCM system. A user may navigate among a set of nodes of the system, the nodes arranged in a predetermined hierarchy. Each node may have parent, child, and sibling relationships with other nodes.

The system may include a server 200. For example, the server 200 may include a processor configured to execute one or more browser provider 202. The server 200 may also be configured to execute a HCM system or any other enterprise system, which includes object types modeled as nodes.

The browser provider 202 may be configured to provide information related to hierarchy and relationships among nodes. Each group of nodes in the system may be associated with a browser provider 202, which are easily added or modified for new groups of nodes. For example, new object types may be supported by simply adding an associated browser provider 202. For example, a group of nodes may be nodes that all relate to a single root node. For example, a group of nodes may be nodes that are logically related.

The server 200 may be in communication with a memory 204. The memory 204 may be configured to store one or more nodes 206 and one or more entity tables 208. A node 206 may represent an object or object type within the HCM system. An entity table 208 may include information associated with a node 206.

The server 200 may be in communication with a terminal 212 over a network 210. The network 210 may be configured to carry digital information. For example, the network 210 may be the Internet or another network. The terminal 212 may be a user-accessible computing device, such as a personal computer, a cellular device, etc.

The terminal 212 may execute a browser 214, which provides a user interface to the HCM system to a user 216. The browser 214 may be a conventional browser, for example, a web browser, or a proprietary browser designed for the HCM system. The browser may be configured to allow a user to navigate among a hierarchy of nodes, for example, object types in the HCM system.

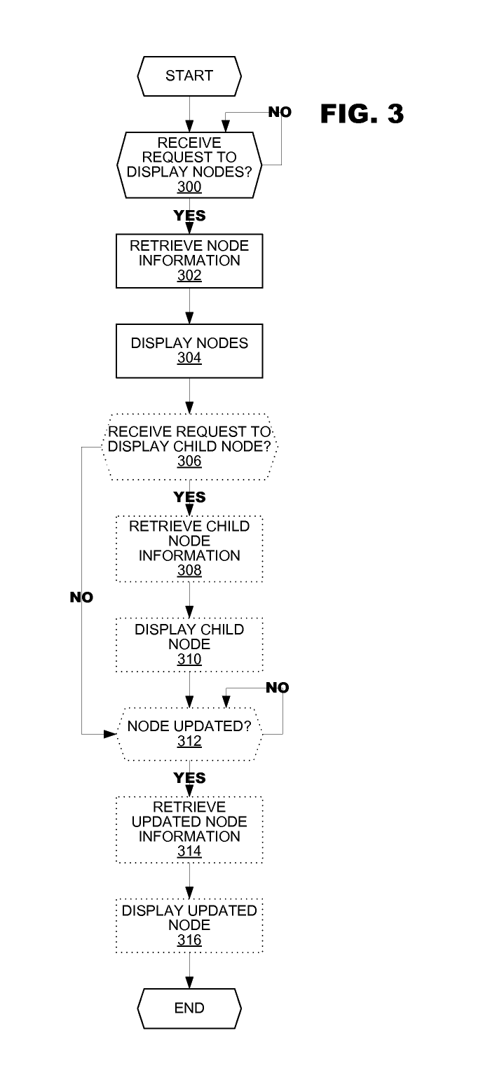

FIG. 3 depicts an example procedure for navigating a set of nodes in accordance with an embodiment of the present invention. The procedure may execute on a system as depicted in FIG. 2.

In 300, the procedure may test whether a request has been received to display nodes. For example, a user may interact with a browser to request a display of nodes. Each node may represent an object or object type in the system. If a request has been received, the procedure may proceed to 302. If a request has not been received, the procedure may wait at 300 until a request is received.

In 302, the procedure may retrieve node information. For example, node information may be retrieved in a process as depicted in FIG. 1A. For each node to be displayed, node information is retrieved from an accessible memory.

In 304, the procedure may display the nodes retrieved in 302. The nodes may be displayed graphically, representing any relationships between the nodes as well as other information. For example, each node may be associated with a node name, a node context menu, a node icon, and child/parent relationships.

In 306, the procedure may optionally test whether a request has been received to display child nodes. For example, the user may click on a node displayed in 304 to expand it in order to view any children nodes. If a request is received, the procedure may proceed to 308. If a request has not been received, the procedure may proceed to 312.

For example, a child node may be expanded from a parent node through a process depicted in FIG. 1B.

In 308, the procedure may optionally retrieve child node information associated with the child node to be displayed. Child node information may be similar to node information retrieved in 302, but associated with the child node.

In 310, the procedure may optionally display the child node, similar to 304.

In 312, the procedure may optionally check whether nodes displayed in 304 and 310 have been updated. For example, object types may be modified in the system, which would require an updating of displayed nodes. If nodes have been updated, the procedure may proceed to 314. If no, the procedure may remain at 312.

In 314, the procedure may optionally retrieve updated node information from the nodes that were updated. Updated node information may be retrieved similar to 302 and 308.

In 316, the procedure may optionally display the updated node information retrieved in 314.

The procedure may then end.

In embodiments, a hierarchy may be nested. For example, a first set of nodes may be accessed via a first browser provider. A second set of nodes may be children of a node within the first set of nodes. The second set of nodes may be accessed via a second browser provider. Thus, any number of different node types may be displayed in any hierarchy via any number of browser providers.

An example embodiment of the present invention is a method for displaying a hierarchy of nodes. The method may include, responsive to a request to display a set of nodes, requesting node information for each node from a browser provider. The method may include receiving node information for each node to be displayed from the browser provider. The method may include displaying the set of nodes and the node information for each node at a browser to a user. The browser may be at a terminal in communication with a server over a network. The nodes may be objects in a human capital management system. The node information associated with each node may include at least one of: a node name, a node context menu, a node icon, and child/parent relationships. The method may include, responsive to a user input, requesting node information associated with a child node and displaying an updated hierarchy including the child node at the browser. The method may include, responsive to a node information being updated, retrieving the updated node information by the browser provider. The method may include displaying the updated node information at the browser. The method may include, responsive to the request to display a second set of nodes, requesting node information for each node in the second set of nodes from a second browser provider. The method may include receiving node information for each node in the second set of nodes to be displayed from the second browser provider. The method may include displaying the second set of nodes and the node information for each node in the second set of nodes at the browser.

An example embodiment of the present invention is a system for displaying a hierarchy of nodes. The system may include a processor. The processor may be configured to, responsive to a request to display a set of nodes, request node information for each node from a browser provider. The processor may be configured to receive node information for each node to be displayed from the browser provider. The processor may be configured to display the set of nodes and the node information for each node at a browser to a user. The browser may be at a terminal in communication with a server over a network. The nodes may be objects in a human capital management system. The node information associated with each node may include at least one of: a node name, a node context menu, a node icon, and child/parent relationships. The processor may be configured to, responsive to a user input, requesting node information associated with a child node and displaying an updated hierarchy including the child node at the browser. The processor may be configured to, responsive to a node information being updated, retrieving the updated node information by the browser provider. The processor may be configured to display the updated node information at the browser. The processor may be configured to, responsive to the request to display a second set of nodes, requesting node information for each node in the second set of nodes from a second browser provider. The processor may be configured to receive node information for each node in the second set of nodes to be displayed from the second browser provider. The processor may be configured to display the second set of nodes and the node information for each node in the second set of nodes at the browser.

An example embodiment of the present invention is a computer-readable medium storing instructions adapted to execute a method for displaying a hierarchy of nodes. The method may include, responsive to a request to display a set of nodes, requesting node information for each node from a browser provider. The method may include receiving node information for each node to be displayed from the browser provider. The method may include displaying the set of nodes and the node information for each node at a browser to a user. The browser may be at a terminal in communication with a server over a network. The nodes may be objects in a human capital management system. The node information associated with each node may include at least one of: a node name, a node context menu, a node icon, and child/parent relationships. The method may include, responsive to a user input, requesting node information associated with a child node and displaying an updated hierarchy including the child node at the browser. The method may include, responsive to a node information being updated, retrieving the updated node information by the browser provider. The method may include displaying the updated node information at the browser. The method may include, responsive to the request to display a second set of nodes, requesting node information for each node in the second set of nodes from a second browser provider. The method may include receiving node information for each node in the second set of nodes to be displayed from the second browser provider. The method may include displaying the second set of nodes and the node information for each node in the second set of nodes at the browser.

It should be understood that there exist implementations of other variations and modifications of the invention and its various aspects, as may be readily apparent to those of ordinary skill in the art, and that the invention is not limited by specific embodiments described herein. Features and embodiments described above may be combined in various ways. It is therefore contemplated to cover any and all modifications, variations, combinations or equivalents that fall within the scope of the basic underlying principals disclosed and claimed herein.

What is claimed is:

1. A method for displaying a hierarchy of nodes, comprising:
responsive to a request to display a set of nodes, requesting node information for each node from a browser provider;
receiving node information for each node to be displayed from the browser provider; and
displaying the set of nodes and the node information for each node at a browser to a user.

2. The method of claim 1, wherein the browser is at a terminal in communication with a server over a network.

3. The method of claim 2, wherein the nodes are objects in a human capital management system.

4. The method of claim 1, wherein the node information associated with each node includes at least one of: a node name, a node context menu, a node icon, and child/parent relationships.

5. The method of claim 4, further comprising:
responsive to a user input, requesting node information associated with a child node and displaying an updated hierarchy including the child node at the browser.

6. The method of claim 1, further comprising:
responsive to a node information being updated, retrieving the updated node information by the browser provider; and
displaying the updated node information at the browser.

7. The method of claim 1, further comprising:
responsive to the request to display a second set of nodes, requesting node information for each node in the second set of nodes from a second browser provider;
receiving node information for each node in the second set of nodes to be displayed from the second browser provider; and
displaying the second set of nodes and the node information for each node in the second set of nodes at the browser.

8. A system for displaying a hierarchy of nodes, comprising:
a processor, the processor configured to,
responsive to a request to display a set of nodes, request node information for each node from a browser provider,
receive node information for each node to be displayed from the browser provider, and
display the set of nodes and the node information for each node at a browser to a user.

9. The system of claim 8, wherein the browser is at a terminal in communication with a server over a network.

10. The system of claim 9, wherein the nodes are objects in a human capital management system.

11. The system of claim 8, wherein the node information associated with each node includes at least one of: a node name, a node context menu, a node icon, and child/parent relationships.

12. The system of claim 11, the processor further configured to,
responsive to a user input, request node information associated with a child node and displaying an updated hierarchy including the child node at the browser.

13. The system of claim 8, the processor further configured to,
responsive to a node information being updated, retrieve the updated node information by the browser provider; and
display the updated node information at the browser.

14. The system of claim 8, the processor further configured to,
responsive to the request to display a second set of nodes, request node information for each node in the second set of nodes from a second browser provider;
receive node information for each node in the second set of nodes to be displayed from the second browser provider; and
display the second set of nodes and the node information for each node in the second set of nodes at the browser.

15. A computer-readable medium storing instructions adapted to execute a method for displaying a hierarchy of nodes, the method comprising:
responsive to a request to display a set of nodes, requesting node information for each node from a browser provider;
receiving node information for each node to be displayed from the browser provider; and
displaying the set of nodes and the node information for each node at a browser to a user.

16. The medium of claim 15, wherein the browser is at a terminal in communication with a server over a network.

17. The medium of claim 16, wherein the nodes are objects in a human capital management system.

18. The medium of claim 15, wherein the node information associated with each node includes at least one of: a node name, a node context menu, a node icon, and child/parent relationships.

19. The medium of claim 18, the method further comprising:
responsive to a user input, requesting node information associated with a child node and displaying an updated hierarchy including the child node at the browser.

20. The medium of claim 15, the method further comprising:
responsive to a node information being updated, retrieving the updated node information by the browser provider;
displaying the updated node information at the browser;
responsive to the request to display a second set of nodes, requesting node information for each node in the second set of nodes from a second browser provider;
receiving node information for each node in the second set of nodes to be displayed from the second browser provider; and
displaying the second set of nodes and the node information for each node in the second set of nodes at the browser.
